(19) United States
(12) Patent Application Publication
(10) Pub. No.: US 2018/0162279 A1
(43) Pub. Date: Jun. 14, 2018

(54) Walkway and safety rail apparatus.

(71) Applicants: Todd Eicher, Beloit, WI (US); Paul Krueger, Beloit, WI (US)

(72) Inventors: Todd Eicher, Beloit, WI (US); Paul Krueger, Beloit, WI (US)

(21) Appl. No.: 15/375,127

(22) Filed: Dec. 11, 2016

(51) Int. Cl. B60R 3/00

(52) U.S. Cl. CPC B60R 3/005

(57) ABSTRACT

A walkway and safety rail apparatus is disclosed for permitting access to a container closure of a tanker truck. The apparatus includes a first walkway disposed in a vicinity of the container closure for permitting access to the container closure and a first safety rail pivotally secured to the first walkway about a horizontal axis such that when the first safety rail is disposed in a first location thereof, access to the container closure is permitted and when the first safety rail is pivoted towards the container closure to a second location thereof, access to the container closure is inhibited.

### BACKGROUND OF THE INVENTION

### Field of the Invention

The present invention relates to a walkway and safety rail apparatus.

More specifically, the present invention relates to a walkway and safety rail apparatus for permitting access to a container closure of a tanker truck.

### Background Information

The present invention relates to a folding railing assembly for a transportation tanker. More specifically, the present invention relates to a remotely controlled folding railing assembly for a transportation tanker vehicle.

The folding railing assembly according to the present invention and as shown in the annexed drawings offers the advantage of providing on board fall protection by extending the folding railing up into the vertical position yet allowing the railing to be folded down when access is needed for site based boom platforms to reach the manway. The folding railing according to the present invention also has the advantage of being powered remotely via either an air or electric actuator thus providing a system that is easily used by an operator so that the operator is encouraged to use the arrangement.

Additionally, the folding railing feature of the present invention adds minimal additional weight to the existing walkway railing assembly. Such relatively light weight of the railing according to the present invention is an important advantage because in the transportation industry minimal weight of such railing assembly is always a feature that is sought by those operating a transportation tanker. Also, the safety afforded to the user is an important feature sought by tanker fleet operators.

Therefore, it is a primary feature of the present invention to provide a walkway and safety rail apparatus that overcomes the problems associated with the prior art arrangements.

Another feature of the present invention is the provision of a walkway and safety rail apparatus that is extremely light in weight thus minimizing the cost of operating a tanker truck fitted with such apparatus.

A further feature of the present invention is the provision of a walkway and safety rail apparatus that is maintained on board the tanker truck and which provides safety and ease of access to the operator thereof.

Another feature of the present invention is the provision of a walkway and safety rail apparatus that is remotely controlled by the operator thereof.

Other features and advantages of the present invention will be readily apparent to those skilled in the art by a consideration of the detailed description of a preferred embodiment of the present invention contained herein.

### SUMMARY OF THE INVENTION

The present invention relates to a walkway and safety rail apparatus for permitting access to a container closure of a tanker truck. The apparatus includes a first walkway disposed in a vicinity of the container closure for permitting access to the container closure and a first safety rail pivotally secured to the first walkway about a horizontal axis. The arrangement is such that, when the first safety rail is disposed in a first location thereof, access to the container closure is permitted and when the first safety rail is pivoted towards the container closure to a second location thereof, access to the container closure is inhibited.

In a more specific embodiment of the present invention, an arm has a first and a second anchor point. The first anchor point of the arm is pivotally secured to the first safety rail and the second anchor point of the arm is pivotally secured adjacent to the container closure.

Moreover, an actuator has a first and a second extremity, the first extremity of the actuator being pivotally secured to the arm between the first and the second anchor points of the arm. The arrangement is such that when the actuator is in a first disposition thereof, the first safety rail is disposed in the first location thereof for permitting access to the container closure and when the actuator is in a second disposition thereof, the first safety rail is disposed in the second location thereof for preventing access to the container closure.

Also, a fixed portion has a first and a second end and a first and a second side, the fixed portion being rigidly secured to the container in a vicinity of the closure.

The fixed portion includes a second walkway having a first and a second termination, the second walkway being disposed adjacent to the first end of the fixed portion. A third walkway has a first and a second edge, the third walkway being disposed adjacent to the second end of the fixed portion. The third walkway is disposed spaced and parallel relative to the second walkway. A fourth walkway has a first and a second border, the fourth walkway extending between the second and the third walkways. The fourth walkway is disposed adjacent to the second side of the fixed portion, such that the container closure is disposed between the second and the third walkways.

Furthermore, the second termination of the second walkway abuts against the first border of the fourth walkway. The second edge of the third walkway abuts against the first border of the fourth walkway.

Additionally, the first walkway includes an elongate walkway having a first and a second boundary.

Moreover, steps are provided, the steps having a first and a second part. The steps are rigidly secured to the second boundary of the elongate walkway.

The first part of the steps is rigidly secured to the second boundary of the elongate walkway and the second part of the steps is disposed adjacent to the first side of the fixed portion.

A second safety rail extends from the elongate walkway, the second safety rail and the first safety rail define therebetween an opening for permitting a user to access the elongate walkway when the first safety rail is disposed in the first location thereof.

Also, an extension extends between the second safety rail and the second part of the steps for preventing a user from falling from the elongate walkway.

The actuator includes a cylinder and a piston is slidably disposed within the cylinder. A rod is secured to the piston such that when a source of pressurized fluid is connected to the cylinder, the cylinder and the rod secured thereto move relative to the cylinder.

An end of the rod remote from the cylinder is pivotally connected to the arm so that when the source of pressurized fluid is connected to the cylinder, the first safety rail moves from the first location to the second location thereof.

Preferably, the source of pressurized fluid is compressed air.

In an alternative embodiment of the present invention, the actuator includes an electric motor for driving the first safety rail between the first and second location thereof.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a walkway and safety rail apparatus according to the present invention for permitting access to a container closure of a tanker truck;

FIG. 2 is a similar view to that shown in FIG. 1 but shows the first safety rail having been pivoted towards the container closure to a second location thereof.

FIG. 3 is a view taken on the line 3-3 of FIG. 1;

FIG. 4 is a view taken on the line 4-4 of FIG. 2;

FIG. 5 is an enlarged view partially in section of the actuator;

FIG. 6 is an enlarged view partially in section of an alternative embodiment of the present invention;

FIG. 7 is a top plan view of the apparatus shown in FIG. 1;

FIG. 8 is a side elevational view of the apparatus shown in FIG. 1;

FIG. 9 is a side elevational view of a further embodiment of a walkway and safety rail apparatus according to the present invention for permitting access to a container closure of a tanker truck;

FIG. 10 is a view taken on the line 10-10 shown in FIG. 9 showing the safety rail in the open first location thereof;

FIG. 11 is a similar view to that shown in FIG. 10 but shows the safety rail in the closed second location thereof; and

FIG. 12 is a view taken on the line 12-12 of FIG. 9 but showing the safety rail in the closed second location thereof as shown in FIG. 11.

Similar reference characters refer to similar parts throughout the various views and embodiments of the drawings.

### DETAILED DESCRIPTION OF THE DRAWINGS

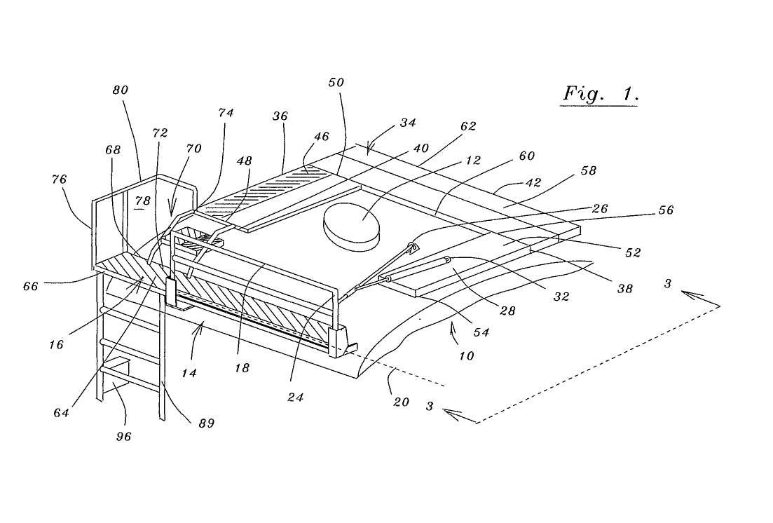

FIG. 1 is a perspective view of a walkway and safety rail apparatus generally designated 10 according to the present invention for permitting access to a container closure 12 of a tanker truck generally designated 14. As shown in FIG. 1, the apparatus 10 includes a first walkway generally designated 16 disposed in a vicinity of the container closure 12 for permitting access to the container closure 12 and a first safety rail 18 pivotally secured to the first walkway 16 about a horizontal axis 20. The arrangement is such that when the first safety rail 18 is disposed in a first location thereof as shown in FIG. 1, access to the container closure 12 is permitted.

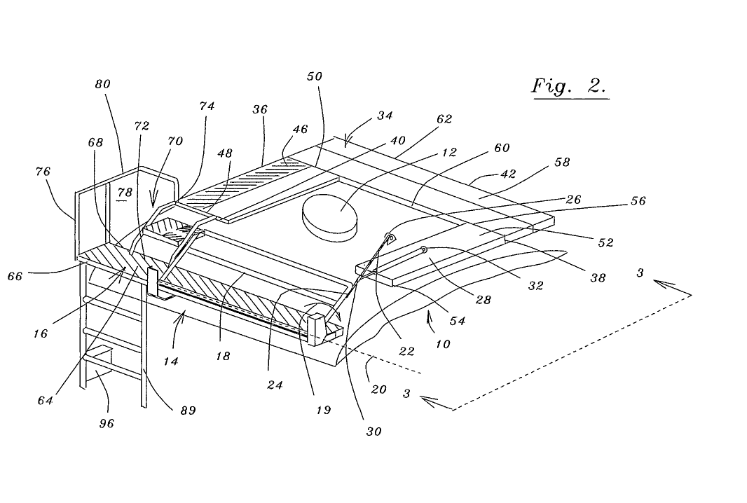

FIG. 2 is a similar view to that shown in FIG. 1 but shows the first safety rail 18 having been pivoted as indicated by the arrow 19 towards the container closure 12 to a second location thereof. In the second location of the first safety rail 18, access to the container closure 12 is inhibited.

In a more specific embodiment of the present invention, an arm 22 has a first and a second anchor point 24 and 26 respectively. The first anchor point 24 of the arm 22 is pivotally secured to the first safety rail 18 and the second anchor point 26 of the arm 22 is pivotally secured adjacent to the container closure 12.

Moreover, an actuator 28 has a first and a second extremity 30 and 32 respectively. The first extremity 30 of the actuator 28 is pivotally secured to the arm 22 between the first and the second anchor points 24 and 26 respectively of the arm 22. The arrangement is such that when the actuator 28 is in a first disposition thereof as shown in FIG. 1, the first safety rail 18 is disposed in the first location thereof for permitting access to the container closure 12. However, when the actuator 28 is in a second disposition thereof as shown in FIG. 2, the first safety rail 18 is disposed in the second location thereof for preventing access to the container closure 12.

Also, a fixed portion generally designated 34 has a first and a second end 36 and 38 respectively and a first and a second side 40 and 42 respectively, the fixed portion 34 being rigidly secured to the container 44 in a vicinity of the container closure 12.

The fixed portion 34 includes a second walkway 46 having a first and a second termination 48 and 50, the second walkway 46 being disposed adjacent to the first end 36 of the fixed portion 34. A third walkway 52 has a first and a second edge 54 and 56 respectively, the third walkway 52 being disposed adjacent to the second end 38 of the fixed portion 34. The third walkway 52 is disposed spaced and parallel relative to the second walkway 46. A fourth walkway 58 has a first and a second border 60 and 62 respectively, the fourth walkway 58 extending between the second and the third walkways 46 and 52 respectively. The fourth walkway 58 is disposed adjacent to the second side 42 of the fixed portion 34, such that the container closure 12 is disposed between the second and the third walkways 46 and 52 respectively.

Furthermore, the second termination 50 of the second walkway 46 abuts against the first border 60 of the fourth walkway 58. The second edge 56 of the third walkway 52 abuts against the first border 60 of the fourth walkway 58.

Additionally, the first walkway 16 includes an elongate walkway 64 having a first and a second boundary 66 and 68 respectively.

Moreover, steps generally designated 70 are provided, the steps 70 having a first and a second parts 72 and 74 respectively. The steps 70 are rigidly secured to the second boundary 68 of the elongate walkway 64.

The first part 72 of the steps 70 is rigidly secured to the second boundary 68 of the elongate walkway 64 and the second part 74 of the steps 70 is disposed adjacent to the first side 40 of the fixed portion 34.

A second safety rail 76 extends from the elongate walkway 64. The second safety rail 76 and the first safety rail 18 define therebetween an opening 78 for permitting a user to access the elongate walkway 64 when the first safety rail 18 is disposed in the first location thereof as shown in FIG. 1.

Also, an extension 80 extends between the second safety rail 76 and the second part 74 of the steps 70 for preventing a user from falling from the elongate walkway 64.

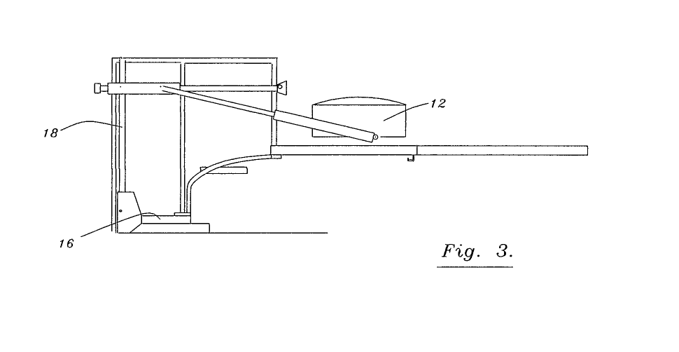

FIG. 3 is a view taken on the line 3-3 of FIG. 1. As shown in FIG. 3, the first safety rail 18 is shown in the first location thereof and is disposed in a vertical position for permitting a user standing on the first walkway 16 to gain access to the container closure 12 for opening or closing the same.

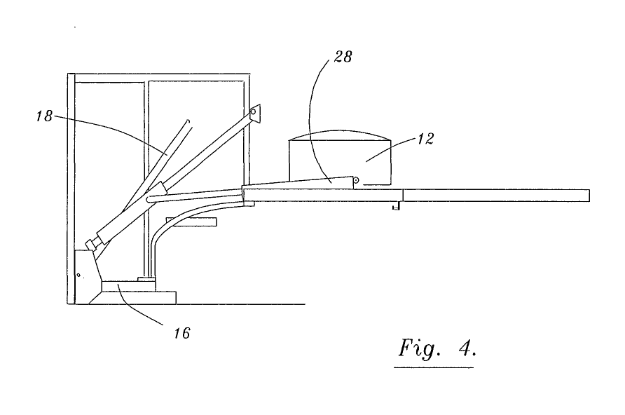

FIG. 4 is a view taken on the line 4-4 of FIG. 2. As shown in FIG. 4, the first safety rail 18 has been moved by the actuator 28 from the first location thereof to the second location thereof. In the second location of the first safety rail 18, the first safety rail 18 blocks access to the container closure 12. More specifically, the first safety rail 18 is disposed in a generally oblique disposition relative to the first walkway 16 for inhibiting any movement of the user along the first walkway 16 towards the container closure 12.

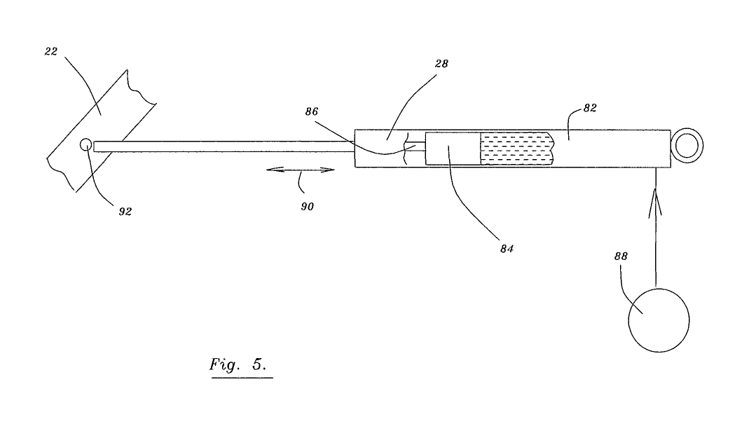

FIG. 5 is an enlarged view partially in section of the actuator 28. As shown in FIG. 5, the actuator 28 includes a cylinder 82 and a piston 84 is slidably disposed within the cylinder 82. A rod 86 is secured to the piston 84 such that when a source of pressurized fluid 88 is connected to the cylinder 82, the piston 84 and the rod 86 secured thereto move as indicated by the arrow 90 relative to the cylinder 82.

An end 92 of the rod 86 remote from the cylinder 82 is pivotally connected to the arm 22 so that when the source of pressurized fluid 88 is connected to the cylinder 82, the first safety rail 18 moves from the first location as shown in FIGS. 1 and 3 to the second location thereof as shown in FIGS. 2 and 4.

Preferably, the source of pressurized fluid 88 is compressed air.

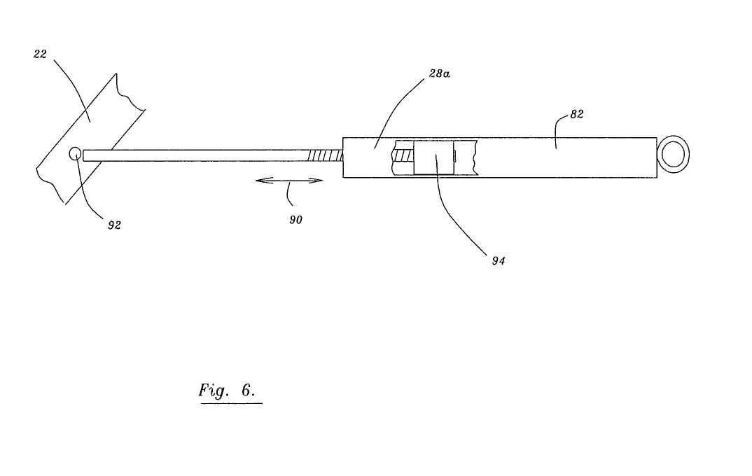

FIG. 6 is an enlarged view partially in section of an alternative embodiment of the present invention. As shown in FIG. 6, an actuator 28a includes an electric motor 94 for driving the first safety rail 18 between the first and second location thereof.

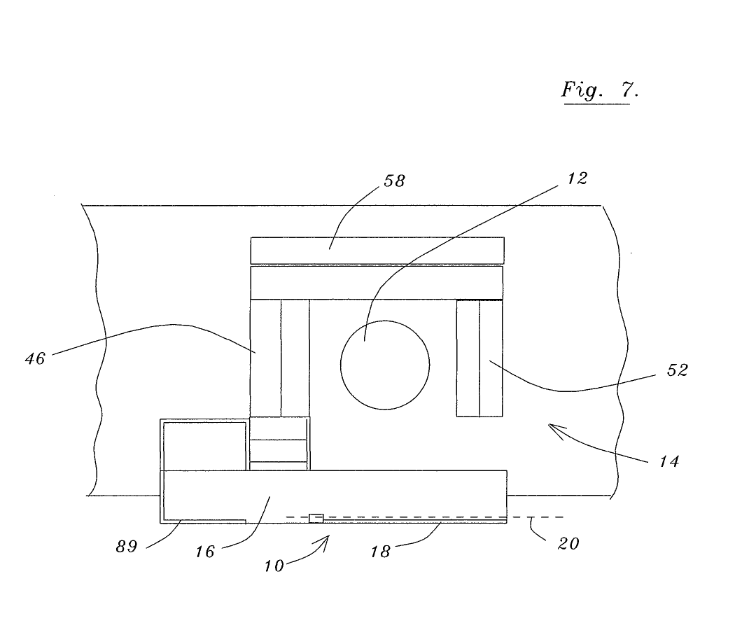

FIG. 7 is a top plan view of the apparatus 10 shown in FIG. 1. As shown in FIG. 7, the apparatus 10 includes a first, second, third and fourth walkway 16, 46, 52 and 58 respectively.

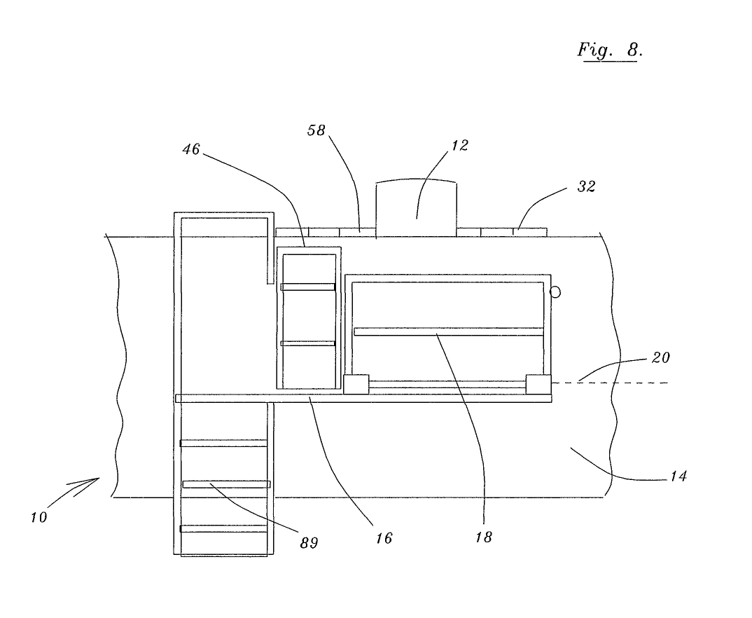

FIG. 8 is a side elevational view of the apparatus 10 shown in FIG. 1. As shown in FIG. 8, the first safety rail 18 is pivoted about the horizontal axis 20.

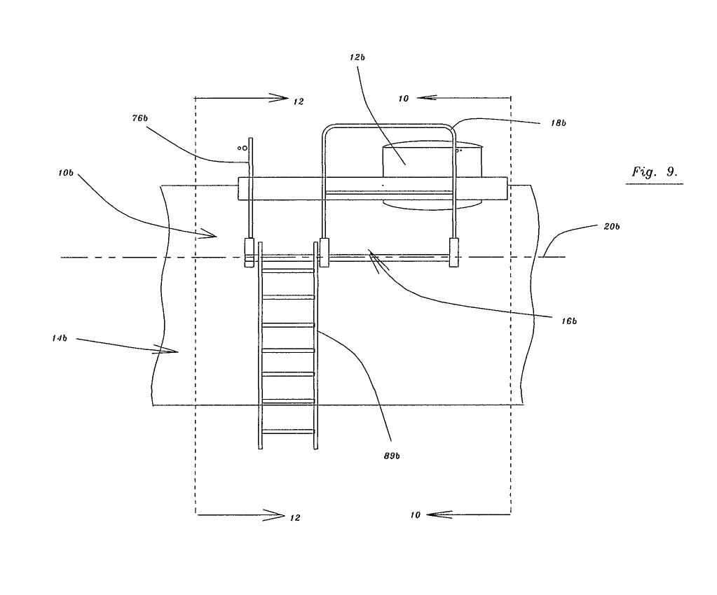

FIG. 9 is a side elevational view of a further embodiment of a walkway and safety rail apparatus generally designated 10b according to the present invention for permitting access to a container closure 12b of a tanker truck generally designated 14b.

As shown in FIG. 9, the apparatus 10b includes a first walkway generally designated 16b disposed in a vicinity of the container closure 12b for permitting access to the container closure 12b and a first safety rail 18b pivotally secured to the first walkway 16b about a horizontal axis 20b. The arrangement is such that when the first safety rail 18b is disposed in a first location thereof as shown in FIG. 9, access to the container closure 12b is permitted.

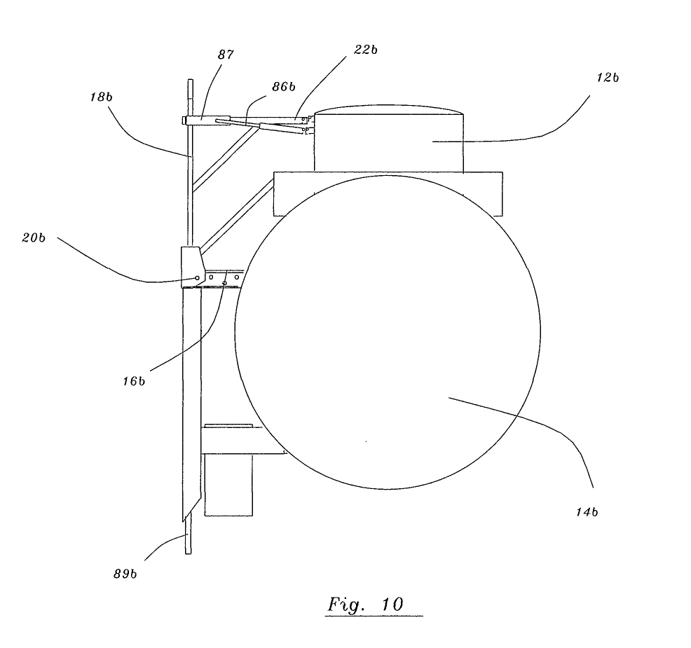

FIG. 10 is a view taken on the line 10-10 shown in FIG. 9 showing the first safety rail 18b in the open first location thereof.

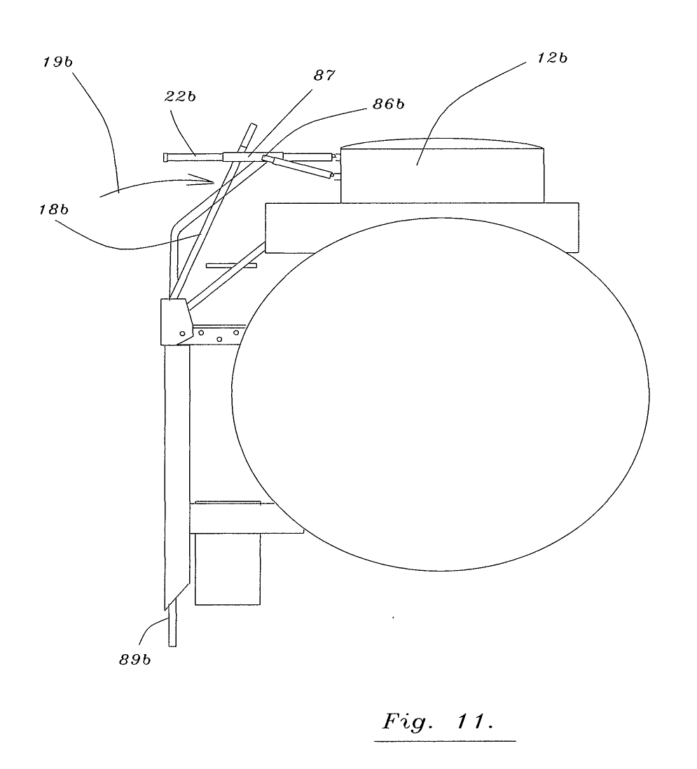

FIG. 11 is a similar view to that shown in FIG. 10 but shows the safety rail 18b in the closed second location thereof.

As shown in FIG. 11, the first safety rail 18b has been pivoted as indicated by the arrow 19b towards the container closure 12b to a second location thereof. In the second location of the first safety rail 18b, access to the container closure 12b is inhibited.

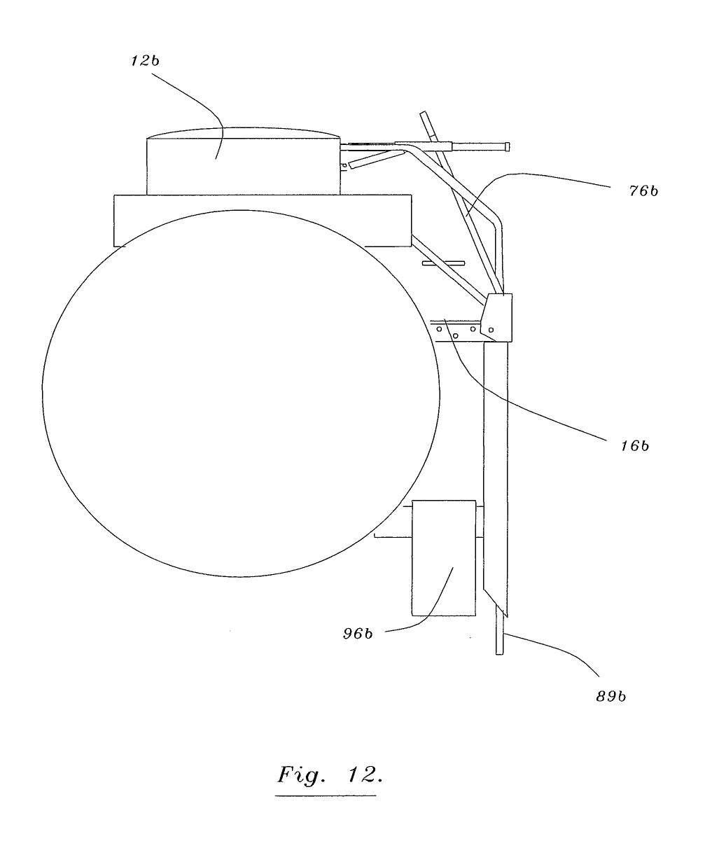

FIG. 12 is a view taken on the line 12-12 of FIG. 9 but shows the safety rail 18b in the closed second location thereof as shown in FIG. 11. As shown in FIG. 12, a control box 96b permits movement of the first safety rail 18b and a second safety rail 76b between the first and second locations thereof. Also, as shown in FIGS. 10 and 11, a rod 86b is pivotally connected to a sleeve 87 which is slidable axially along the arm 22b.

In operation of the apparatus 10 according to the present invention, at the arrival of the tanker truck 14 at the loading or unloading site, the driver will remotely control the movement of the first safety rail 18 between the first and second locations thereof. The driver will control this movement from the cab or from an outside control box 96 secured at a level which is within the reach of the driver standing at ground level. The driver or other user of the apparatus 10 will then climb the vertical ladders 89 and will step onto the elongate first walkway 16 through the opening 78 between the first and second safety rails 18 and 76 respectively. The user can then move along the first walkway 16. The first safety rail 18 acts as a safety rail for permitting access to the container closure 12 and will prevent the user from falling from the first walkway 16 when the first safety rail 18 is in the first location thereof as shown in FIG. 1. The user moves along the first walkway 16 to the right as shown in FIG. 1. The user can then unlatch the container closure 12. The user can then climb up the steps 70 onto the fixed portion 34 and can move around on the second, third and fourth walkway 46, 52 and 58 respectively to inspect the inside of the container 44 through the unlatched container closure 12. The filling or emptying equipment, (not shown) can be guided through the unlatched container closure 12. When the container 44 has been filled or emptied, the user climbs down the steps 70 and moves along the first walkway 16 to relatch or close the container closure 12. The first and second safety rail 18 and 76 respectively will prevent the user from falling from the steps 70 or from the first walkway 16. The user can then operate the control box 96 to move the first safety rail 18 to the second location thereof as shown in FIG. 2 and as indicated by the arrow 19 for preventing further access to the container closure 12.

The apparatus according to the present invention provides a unique and lightweight onboard arrangement for safely permitting a user thereof to easily gain access to the container closure.

### GLOSSARY

10 walkway and safety rail apparatus.
12 container closure.
14 tanker truck.
16 first walkway
18 first safety rail
19 arrow
20 horizontal axis
22 an arm
24 first anchor point
26 second anchor point
28 actuator
30 first extremity
32 second extremity
34 fixed portion
36 first end of 34
38 second end of 34
40 first side of 34
42 second side of 34
44 container
46 second walkway
48 first termination of 46
50 second termination of 46
52 third walkway
54 first edge of 52
56 second edge of 52
58 fourth walkway
60 first border of 58
62 second border of 58
64 elongate walkway
66 first boundary of 64
68 second boundary of 64
70 steps
72 first part of 70
74 second part of 70
76 second safety rail
78 opening
80 extension
82 cylinder
84 piston
86 rod
87b sleeve
88 source of pressurized fluid
89 ladders
90 arrow
92 end of 86
94 electric motor
96 control box

What is claimed is:

1. A walkway and safety rail apparatus for permitting access to a container closure of a tanker truck, said apparatus comprising:
a first walkway disposed in a vicinity of the container closure for permitting access to the container closure; and
a first safety rail pivotally secured to said first walkway about a horizontal axis such that when said first safety rail is disposed in a first location thereof, access to the container closure is permitted and when said first safety rail is pivoted towards the container closure to a second location thereof, access to the container closure is inhibited.

2. A walkway and safety rail apparatus as set forth in claim 1 further including:
an arm having a first and a second anchor point;
said first anchor point of said arm being pivotally secured to said first safety rail;
said second anchor point of said arm being pivotally secured adjacent to the container closure;
an actuator having a first and a second extremity, said first extremity of said actuator being pivotally secured relative to said arm between said first and said second anchor points of said arm such that when said actuator is in a first disposition thereof, said first safety rail is disposed in said first location thereof for permitting access to the container closure and when said actuator is in a second disposition thereof, said first safety rail is disposed in said second location thereof for preventing access to the container closure.

3. A walkway and safety rail apparatus as set forth in claim 1 further including:
a fixed portion having a first and a second end and a first and a second side, said fixed portion being rigidly secured to the container in a vicinity of the closure.

4. A walkway and safety rail apparatus as set forth in claim 3 wherein
said fixed portion includes:
a second walkway having a first and a second termination, said second walkway being disposed adjacent to said first end of said fixed portion;
a third walkway having a first and a second edge, said third walkway being disposed adjacent to said second end of said fixed portion, said third walkway being disposed spaced and parallel relative to said second walkway;
a fourth walkway having a first and a second border, said fourth walkway extending between said second and said third walkways, said fourth walkway being disposed adjacent to said second side of said fixed portion, such that the container closure is disposed between said second and said third walkways.

5. A walkway and safety rail apparatus as set forth in claim 4 wherein
said second termination of said second walkway abuts against said first border of said fourth walkway;
said second edge of said third walkway abuts against said first border of said fourth walkway.

6. A walkway and safety rail apparatus as set forth in claim 3 wherein
said first walkway includes:
an elongate walkway having a first and a second boundary.

7. A walkway and safety rail apparatus as set forth in claim 6 further including:
steps having a first and a second part, said steps being rigidly secured to said second boundary of said elongate walkway.

8. A walkway and safety rail apparatus as set forth in claim 7 wherein
said first part of said steps is rigidly secured to said second boundary of said elongate walkway;
said second part of said steps is disposed adjacent to said first side of said fixed portion.

9. A walkway and safety rail apparatus as set forth in claim 7 further including:
a second safety rail extending from said elongate walkway, said second safety rail and said first safety rail defining therebetween an opening for permitting a user to access said elongate walkway when said first safety rail is disposed in said first location thereof.

10. A walkway and safety rail apparatus as set forth in claim 9 further including:
an extension extending between said second safety rail and said second part of said steps for preventing a user from falling from said elongate walkway.

11. A walkway and safety rail apparatus as set forth in claim 2 wherein
said actuator includes:
a cylinder;
a piston slidably disposed within said cylinder;
a rod secured to said piston such that when a source of pressurized fluid is connected to said cylinder, said cylinder and said rod secured thereto move relative to said cylinder;
an end of said rod remote from said cylinder being pivotally connected relative to said arm so that when said source of pressurized fluid is connected to said cylinder, said first safety rail moves from said first location to said second location thereof.

12. A walkway and safety rail apparatus as set forth in claim 11 wherein
said source of pressurized fluid is compressed air.

13. A walkway and safety rail apparatus as set forth in claim 2 wherein
said actuator includes:
an electric motor for driving said first safety rail between said first and second location thereof.

14. A walkway and safety rail apparatus for permitting access to a container closure of a tanker truck, said apparatus comprising:
a first walkway disposed in a vicinity of the container closure for permitting access to the container closure;
a first safety rail pivotally secured to said first walkway about a horizontal axis such that when said first safety rail is disposed in a first location thereof, access to the container closure is permitted and when said first safety rail is pivoted towards the container closure to a second location thereof, access to the container closure is inhibited; and
an actuator for moving said first safety rail between said first and said second location thereof.

15. A walkway and safety rail apparatus for permitting access to a container closure of a tanker truck, said apparatus comprising:
a first walkway disposed in a vicinity of the container closure for permitting access to the container closure;
a first safety rail pivotally secured to said first walkway about a horizontal axis such that when said first safety rail is disposed in a first location thereof, access to the container closure is permitted and when said first safety rail is pivoted towards the container closure to a second location thereof, access to the container closure is inhibited;
an arm having a first and a second anchor point;
said first anchor point of said arm being pivotally secured to said first safety rail;
said second anchor point of said arm being pivotally secured adjacent to the container closure;
an actuator having a first and a second extremity, said first extremity of said actuator being pivotally secured to said arm between said first and said second anchor points of said arm such that when said actuator is in a first disposition thereof, said first safety rail is disposed in said first location thereof for permitting access to the container closure and when said actuator is in a second disposition thereof, said first safety rail is disposed in said second location thereof for preventing access to the container closure;
a fixed portion having a first and a second end and a first and a second side, said fixed portion being rigidly secured to the container in a vicinity of the closure;
said fixed portion includes:
a second walkway having a first and a second termination, said second walkway being disposed adjacent to said first end of said fixed portion;
a third walkway having a first and a second edge, said third walkway being disposed adjacent to said second end of said fixed portion, said third walkway being disposed spaced and parallel relative to said second walkway;
a fourth walkway having a first and a second border, said fourth walkway extending between said second and said third walkways, said fourth walkway being disposed adjacent to said second side of said fixed portion, such that the container closure is disposed between said second and said third walkways;
said second termination of said second walkway abuts against said first border of said fourth walkway;
said second edge of said third walkway abuts against said first border of said fourth walkway;
said first walkway includes:
an elongate walkway having a first and a second boundary;
steps having a first and a second part, said steps being rigidly secured to said second boundary of said elongate walkway;
said first part of said steps is rigidly secured to said second boundary of said elongate walkway;
said second part of said steps is disposed adjacent to said first side of said fixed portion;
a second safety rail extending from said elongate walkway, said second safety rail and said first safety rail defining therebetween an opening for permitting a user to access said elongate walkway when said first safety rail is disposed in said first location thereof;
an extension extending between said second safety rail and said second part of said steps for preventing a user from falling from said elongate walkway;
said actuator includes:
a cylinder;
a piston slidably disposed within said cylinder;
a rod secured to said piston such that when a source of pressurized fluid is connected to said cylinder, said cylinder and said rod secured thereto move relative to said cylinder;
an end of said rod remote from said cylinder being pivotally connected to said arm so that when said source of pressurized fluid is connected to said cylinder, said first safety rail moves from said first location to said second location thereof; and
said source of pressurized fluid is compressed air.
